(19) United States
(12) Patent Application Publication
(10) Pub. No.: US 2008/0243292 A1
(43) Pub. Date: Oct. 2, 2008

(54) METHOD OF DEFECT DETECTION BASED ON WAFER ROTATION

(76) Inventor: TZU-YIN CHIU, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/060,073

(22) Filed: Mar. 31, 2008

Related U.S. Application Data
(60) Provisional application No. 60/909,401, filed on Mar. 30, 2007.

(51) Int. Cl. G06F 19/00

(52) U.S. Cl. 700/110

(57) ABSTRACT

A method of identifying defect generating process of a plurality of lots of wafers in a manufacturing environment is provided, wherein each lots of the wafers are divided into a plurality of sub lots of wafers, and dividing all processes into groups of manufacturing stages, the method comprises the steps of: assigning all the sub lots a reference orientation to be processed in a first group of manufacturing stages; rotating one or more of sub lots by designated combination of rotational angles with respect to the reference orientation during each of the subsequent group of manufacturing stages; detecting a defect pattern of the sub lots, wherein the defect pattern corresponds to a rotational combination associated with the designated combination of rotational angles of the sub lots and the number of the plurality of sub lots; and identifying the group of manufacturing stages corresponding to the rotational combination.

### RELATED APPLICATIONS

This application claims priority benefit of U.S. Provisional Application Ser. No. 60/909,401, filed Mar. 30, 2007, which is herein incorporated by reference.

### BACKGROUND

1. Field of Invention

The present invention relates to a method of identifying defect generating process. More particularly, the present invention relates to a method of identifying defect generating process of a plurality of lots of wafers in a manufacturing environment.

2. Description of Related Art

In the yield improvement of semiconductor manufacturing process, it is critical to identify source of defect, detect occurring steps, and/or defect causing machines. In a normal advanced semiconductor process nowadays, we would have around ≧300 stages with each stage having 3-4 steps. Each step may involve one or more manufacturing tool types. In volume manufacturing environment, there may be multiple tools serving the same process steps, (for example, AMAT poly etcher or/and Lam poly etcher for gate etching). FIG. 1 illustrates the nominal volume manufacturing arrangement. The nominal volume manufacturing arrangement includes a number of process stages. Each state may be completed by a number of steps. In each step, groups of process machines are used, sometimes from different tool vendors. Lastly, each machine may have multiple chambers performing the same function. For example, process stage 102 includes steps 104 and 106. Step 104 may be performed by machine group 108 from vendor A, or machine group 110 from vendor B. In machine group 110, machine 112 is a multi-chamber machine having chamber 114, 116, and 118. In volume manufacturing environment, it is imperative to suppress physical defects occurring as much as possible. Normal practice to minimize defect generation is to keep the tools in excellent operating condition. In addition, each process should be well characterized as far away from process condition that may tend to generate physical defect as possible. To keep tools in good operating condition, various PM (preventive maintenance) procedures are installed to keep the tools in clean condition. Regular monitor procedure is used to detect unexpected particle generation event.

However, even with good PM procedure and rigorously practiced monitor, physical defect may still be generated, escaping the detection of regular monitor for the following reasons. Firstly, the process used in the monitor could not always be identical with the actual process. Secondly, not every process has a corresponding daily monitor. Thirdly, defect generation is not continuous. It may be too sporadic or occurring at too low a frequency for the regular monitor to capture. Fourthly, the daily monitor is done by a somewhat inexpensive defect detection tool on blank wafers. Since the wafers are not patterned, some of the pattern sensitive defects are not detectable by monitor wafers as well.

Because physical defects heavily impact the ultimate chip yield, and daily monitor can only detect a subset of all defect generation process, additional defect detection points are installed using very expensive tools to observe wafer under process. Because this type of defect detection is expensive and causes additional process cycle time, it is normal practice to sample predetermined lots and a few predetermined wafers in a lot.

Because of the high cost of monitoring defect on the product wafer, there is a natural tendency to minimize the sampling frequency. A minimized sampling frequency inevitably would cause, on the average, defect incidences to have larger amount of wafers impacted by defect scrap, leading to higher cost. Therefore, there are two opposing requirements, please refer to FIG. 2, FIG. 2 illustrates a curve of the total unit cost, C200, a curve of the sum of the cost of scrap, C204, and a curve of cost of capital, C202. It is imperative to lower the overall cost. Since defect scans are expensive and can only be used on selective process stages, the defect pattern very often is buried underneath layers of material. To identify the defect source, many approaches generally are taken simultaneously, such as tool commonality analysis, matching of defect pattern to data bank, that stores previous detect incidents, and doing destructive analysis by cutting a sample for material analysis.

Often, none of the methods mentioned above provide sufficient information to pin point the defect generating process stage. In addition, cutting of sample invokes high cost, especially when 12″ wafers are involved.

One approach of improving the total unit cost is to develop algorithm to allow identification of defect generating process and, perhaps step or even tool/chamber at a faster rate than available method. This present invention is based on the fact that defect patterns are often repeatable and non symmetric. The invention leverages pattern recognition and wafer rotation to achieve fast defect source identification.

### SUMMARY

The present invention provides a method of identifying defect generating process of a plurality of lots of wafers in a manufacturing environment, wherein each lots of the wafers are divided into a plurality of sub lots of wafers, and dividing all processes into groups of manufacturing stages, the method comprises the steps of: assigning each of the sub lots a reference orientation to be processed in one of the group of manufacturing stages; rotating one or more of sub lots by designated combination of rotational angles with respect to the reference orientation during each of the other group of manufacturing stages, wherein each of the combination of rotational angles of the plurality sub lots corresponds to a group of manufacturing stages respectively; detecting a defect pattern of the sub lots, wherein the defect pattern corresponds to a rotational combination, and the rotational combination is associated with the designated combination of rotational angles of the sub lots and the number of the plurality of sub lots; and identifying the group of manufacturing stages corresponding to the rotational combination.

Another object of the present invention is to provide a method of identifying defect generating process of a plurality of lots of wafers in a manufacturing environment, wherein each lots of the wafers are divided into a plurality of sub lots of wafers, and dividing all manufacturing machines into a plurality of groups of machines, wherein the method comprises the steps of: assigning each of the sub lots a reference orientation whenever encountering processes in one of the group of manufacturing machines; rotating one or more of the remaining sub lots by designated combination of rotational angles with respect to the reference orientation when the sub lots of wafers are processed through each of the other group of manufacturing machines, wherein each of the rotational angle of the plurality sub lots corresponds to the rotational angle of each sub lot and the number of the plurality of sub lots; detecting a defect pattern of the sub lots, wherein the defect pattern corresponds to a rotational combination, and the rotational combination is associated with the designated combination of rotational angles of the sub lots and the number of the plurality of sub lots; and identifying the group of manufacturing machines corresponding to the rotational combination.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates the nominal volume manufacturing arrangement; and

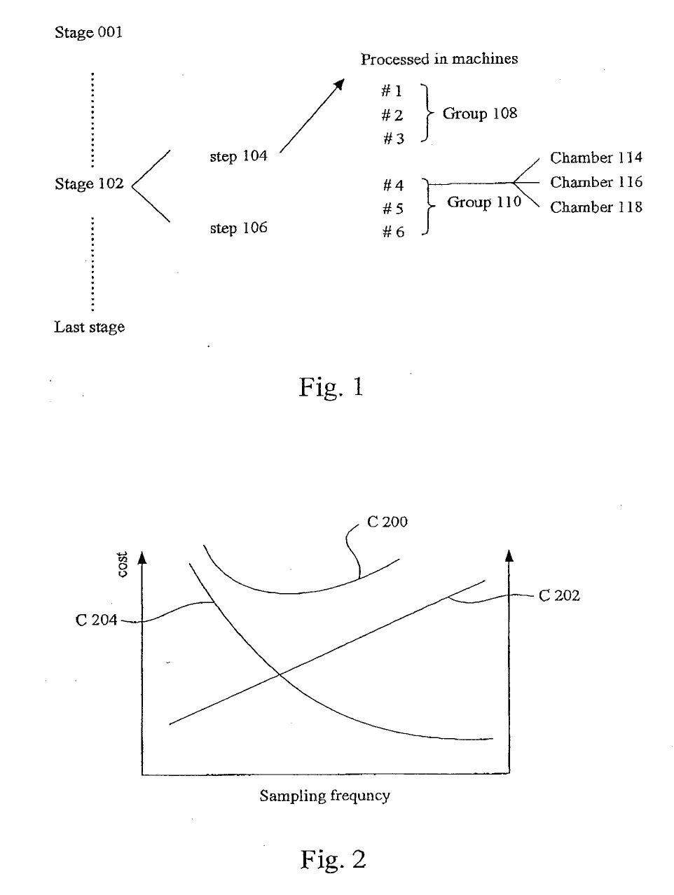

FIG. 2 illustrates the total unit cost and its components, the cost of scrap and the cost of capital.

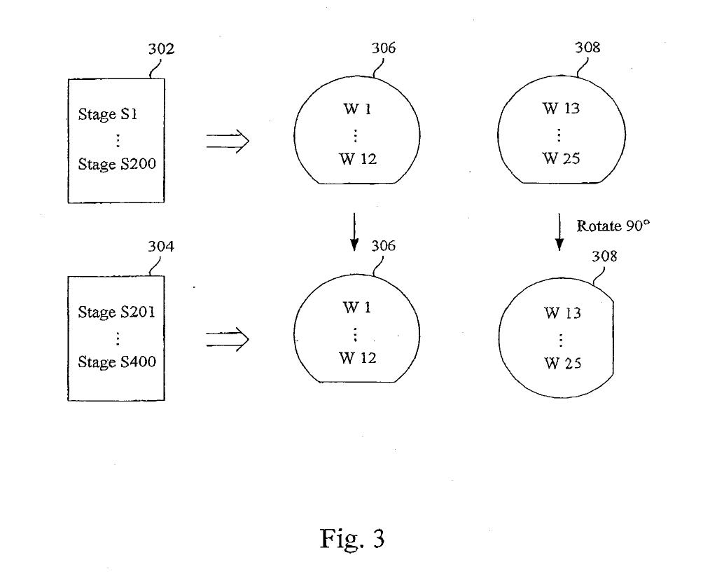

FIG. 3 illustrates an example of the method of detecting one or more groups of processes causing defects in a manufacturing process of wafers according to a first embodiment of the present invention.

FIG. 4 illustrates an example of increasing the number of different rotational angles in each sub lot according to a second embodiment of the present invention.

FIG. 5A and FIG. 5B illustrates an example of improving granularity by offsetting the grouping of processes or machines according to a third embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

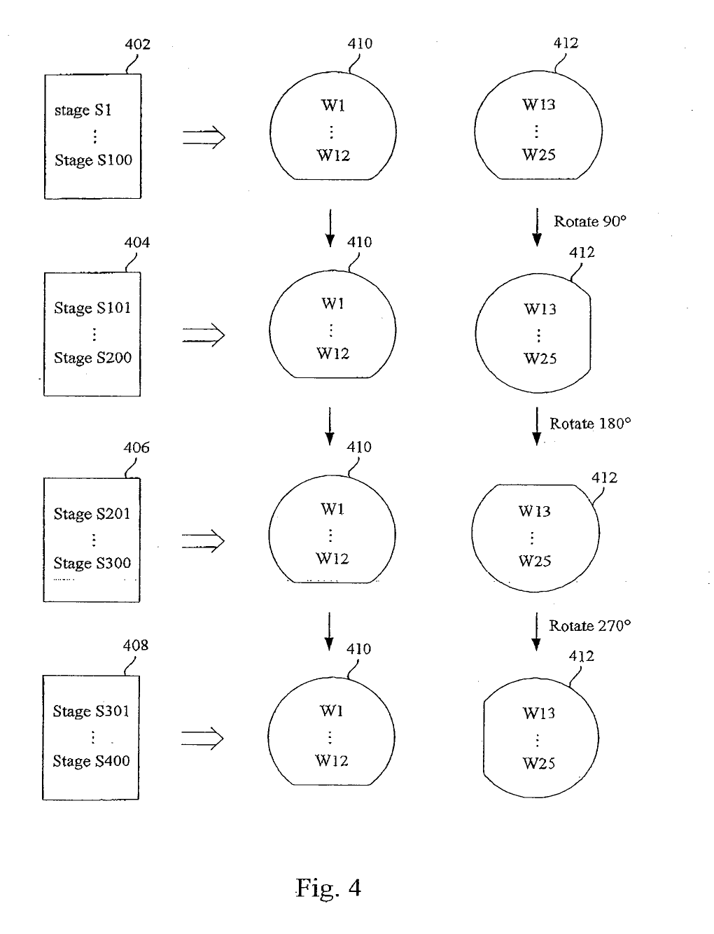

Please refer to FIG. 3, illustrating an example of the method of detecting one or more groups of manufacturing stages causing defects in a manufacturing process of wafers according to a first embodiment of the present invention. In this example, a total of 400 process stages are divided into a first group of manufacturing stages 302, and a second group of manufacturing stages 304, wherein each group includes 200 process stages. In this example, the first group of manufacturing stages 302 includes the manufacturing stages S1-S200, and the second group of manufacturing stages 304 includes the manufacturing stages S201-S400. Next, a lot of 25 wafers are divided into a first sub lot of wafers 306 with wafers W1-W12 and a second sub lot of wafers 308 with wafers W13-W25. While processing through the first group of manufacturing stages 302, the first sub lot 306 and the second sub lot 308 are kept at a reference orientation, such as notch down. While processing through the second group of manufacturing stages 304, the first sub lot 306 remains at the reference orientation while the second sub lot 308 is rotated by an angle of 90 degrees counterclockwise with respect to the reference orientation. In other embodiment, the angle of the rotation can be easily modified by people who are skilled in the art.

Therefore, if a defect pattern is observed having the reference orientation in all the sub lots, one may conclude that the defect is generated during the first group of manufacturing stages 302. If the defect pattern is observed having a clockwise rotation of 90 degrees in the second sub lot 308 with respect to the reference orientation, then one may conclude that the defect occurred during the second group of manufacturing stages 304.

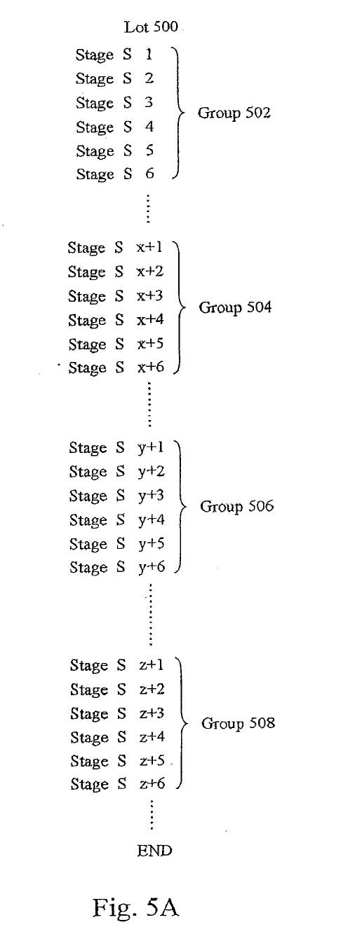

Please refer to FIG. 4, an example of increasing the number of different rotational angles in each sub lot according to a second embodiment of the present invention. With 400 manufacturing stages and 25 wafers in a lot, the manufacturing stages may be divided into a first group of manufacturing stages 402, a second group of manufacturing stages 404, a third group of manufacturing stages 406, and a fourth group of manufacturing stages 408, wherein the first group of manufacturing stages includes manufacturing stages 1-100, the second group of manufacturing stages includes manufacturing stages 101-200, the third group of manufacturing stages includes manufacturing stages 201-300, and the fourth group of manufacturing stages includes manufacturing stages 301-400. The lot of wafers is divided into a first sub lot of wafers 410 and a second sub lot of wafers 412, wherein the first sub lot of wafers 410 includes wafers 1-12, and the second sub lot of wafers 412 includes wafers 13-25. As the wafers are process through the first group of manufacturing stages 402, the first sub lot 410 and the second sub lot 412 are kept at a reference orientation, such as notch down. As the wafers are process through the second group of manufacturing stages 404, the first sub lot 410 remains at the reference orientation while the second sub lot 412 is rotated by an angle, namely, 90 degrees clockwise with respect to the reference orientation. As the wafers are process through the third group of manufacturing stages 406, the first sub lot 410 remains at the reference orientation while the second sub lot 412 is rotated by an angle, namely, 180 degrees with respect to the reference orientation. As the wafers are process through the fourth group of manufacturing stages 408, the first sub lot 410 remains at the reference orientation while the second sub lot 412 is rotated by an angle, namely, 270 degrees clockwise with respect to the reference orientation.

Therefore, if a defect pattern is observed having the reference orientation in all the sub lots, then one may conclude that the defect occurred during the first group of manufacturing stages 402. If the defect pattern is observed having an orientation of 90 degrees in the second sub lot 412 with respect to the reference orientation, then one may conclude that the defect occurred during the second group of manufacturing stages 404. If the defect is observed having an orientation of 180 degrees in the second sub lot 412 with respect to the reference orientation, then one may conclude that the defect occurred during the third group of manufacturing stages 406. If the defect is observed having an orientation of 270 degrees in the second sub lot 412 with respect to the reference orientation, then one may conclude that the defect occurred during the fourth group of manufacturing stages 408.

By the same logic, the number of sub lots may be increased to allow the manufacturing stages to be divided into a greater number of groups. For example, the lot of 25 wafers may be divided into 3 sub lots (a first subs lot, a second sub lot, and a third sub lot). The first sub lot includes wafers 1-8, the second sub lot includes wafers 9-16, and the third sub lot includes wafers 17-25. Using the relationship of the number of rotational angles (4 different angles) and the number of sub lots (3 sub lots) with the first sub lot fixed in its orientation and the remaining sub lots (the second and third sub lot) rotated, yields 16 different combinations, which allow the manufacturing stages to be divided into 16 groups and the defect location can be traced to one of the 16 sections with high probability and confidence.

From the above examples, the number of different rotational angles in each sub lot and the number of sub lots in a lot of wafers determine the number of unique rotational combination as follow:

C=R^{(N-1)} (1)

where C is the number of unique rotational combination, R is the number of different rotational angles in each sub lot, and N is the number of sub lots in a lot. N is deducted by 1 in the exponent because the first sub lot of wafers is always fixed to the reference orientation. The granularity of the groups of manufacturing stages may be refined with an increase in C. If C is greater or equal to the number of groups of manufacturing stages, then each group can be identified by a unique rotational combination.

Thus, for a total of 400 manufacturing stages, if R is 4 and N is 5 or 6, C can be between 256 to 1024. It is possible to have fine enough granularities so that the defect is traced to within 1 to 2 manufacturing stages.

The same methodology may be applied to identify a machines or a group of machines as the source of defect. For example, if 1000 processing machines are used in a fabrication plant, then they may be divided up into groups of machines and by assigning each group of machines with a unique rotational combination, the machine or the group of machines responsible for generating the defect can be identified.

The above embodiments are merely example and are not meant to limit the method disclosed by the present invention to the numerical values described above. Any number of manufacturing stages, machines, groups, lots of wafers, sub lots of wafers, rotational angles, and combinations may the method disclosed be applied thereto. It's also noted that, the group of manufacturing stage (or machine) having the reference orientation need not to be the first group of all the groups. One can easily assign one the groups to have the reference orientation. Also, one can assign more than one sub lot to have a reference orientation respectively according to different situations. The method disclosed may have limitations in its application, if the defect pattern is symmetric or if re-orientation is not possible with some process machines, such as lithography.

Furthermore, the number of different rotational angles in each sub lot and the number of sub lots in a lot should be selected within a reasonable range in order not to degrade the reliability of the information. For example, if the number of rotational angles is large, the rotational angle becomes small. The orientation of the defect pattern becomes difficult to identify especially there may be some variation in the defect pattern from wafer to wafer. Also, if the number of sub lots of wafers is too large, the number of wafers in each sub lot is too small (ex. 2 or 3 wafers in each sub lot), any individual wafer scraps can cause undesired missing information. In addition, if a processing machine involves multiple process chambers, a lack of wafers in each sub lots may not be able to cover all the chambers in each machine.

Lastly, if maintaining the reliability of the identified manufacturing stages or machines requires a reduction of R and N, the granularity thus is limited. In order to obtain finer granularity without increasing R and N, multiple lots of offsetting the grouping of manufacturing stages or machines may be used to improve the granularity.

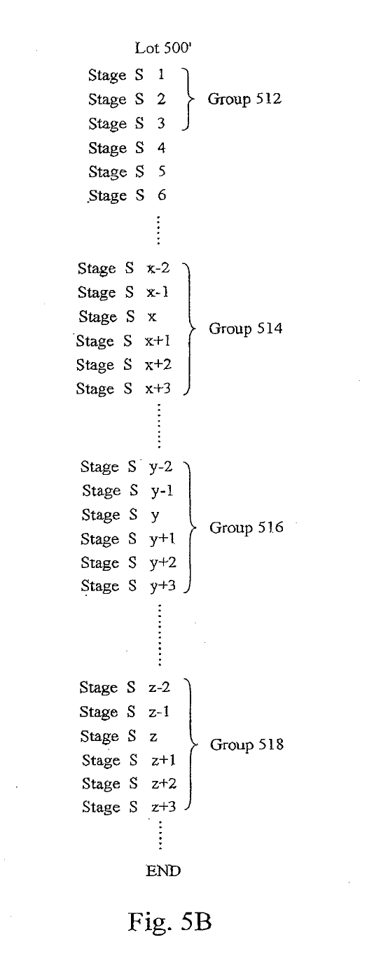

Please refer to FIG. 5A and FIG. 5B, an example of improving granularity by offsetting the grouping of manufacturing stages or machines according to a third embodiment of the present invention. Lot 500 is processed by groups of manufacturing stages, wherein each group includes, in this example, 6 manufacturing stages. Group 502 includes manufacturing stages S1 to S6, group 504 includes manufacturing stages S(X+1) to S(X+6), group 506 includes manufacturing stages S(Y+1) to S(Y+6), and group 508 includes manufacturing stages S(Z+1) to S(Z+6). Lot 500′ is processed by a different rotational segregation, wherein each group also includes 6 manufacturing stages. Group 512 includes manufacturing stages S1 to S3, group 514 includes manufacturing stages S(X−21) to S(X+3), group 516 includes manufacturing stages S(Y−2) to S(Y+3), and group 518 includes manufacturing stages S(Z−2) to S(Z+3) If the location of the defect is identified to be within group 506 in lot 500 and group 516 in lot 500′, then one can conclude that the defect is located within the common manufacturing stages S(Y+1) to S(Y+3), narrowing the range by half. It can further be deduced that by such combination of different lots, and offsetting the grouping of manufacturing stages or machines, one can narrow the range of the defect generating manufacturing stages or machines. By properly designing the sandwiching scheme using multiple lots, the defect generating location may be identified into very fine granularity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of identifying defect generating process of a plurality of lots of wafers in a manufacturing environment, wherein each lots of the wafers are divided into a plurality of sub lots of wafers, and dividing all processes into groups of manufacturing stages, the method comprises the steps of:
assigning each of the sub lots a reference orientation to be processed in one of the group of manufacturing stages;
rotating one or more of sub lots by designated combination of rotational angles with respect to the reference orientation during each of the other group of manufacturing stages, wherein each of the combination of rotational angles of the plurality sub lots corresponds to a group of manufacturing stages respectively;
detecting a defect pattern of the sub lots, wherein the defect pattern corresponds to a rotational combination, and the rotational combination is associated with the designated combination of rotational angles of the plurality of sub lots and the number of the plurality of sub lots; and
identifying the group of manufacturing stages corresponding to the rotational combination.

2. The method of claim 1, wherein the rotational combination is identified by comparing the orientation of the defect patterns with the orientation of a reference defect pattern to obtain the rotational combination of the defect pattern.

3. The method of claim 2, wherein the plurality of sub lots of wafers comprises a reference sub lot of wafer, and the reference sub lot of wafer remains at the reference orientation during each of the subsequent group of manufacturing stages and acts as a reference defect pattern when a defect pattern is detected.

4. The method of claim 1, wherein each group of manufacturing stages comprises at least one manufacturing step.

5. The method of claim 1, wherein each of the sub lot of wafers comprises at least one wafer.

6. The method of claim 1, wherein a granularity of the groups of manufacturing stages is improved by decreasing the magnitude of the rotational angels of the designated combination of rotational angles.

7. The method of claim 1, wherein a granularity of the groups of manufacturing stages is improved by increasing the number of the sub lots.

8. The method of claim 1, wherein a granularity of the groups of manufacturing stages is improved by offsetting the grouping of manufacturing stages of each lots of the wafers.

9. A method of identifying defect generating process of a plurality of lots of wafers in a manufacturing environment, wherein each lots of the wafers are divided into a plurality of sub lots of wafers, and dividing all manufacturing machines into a plurality of groups of machines, wherein the method comprises the steps of;
assigning each of the sub lots a reference orientation to be processed in one of the group of manufacturing machines;
rotating one or more of the remaining sub lots by designated combination of rotational angles with respect to the reference orientation when the sub lots of wafers are processed through each of the other group of manufacturing machines, wherein each of the rotational angle of the plurality sub lots corresponds to the rotational angle of each sub lot and the number of the plurality of sub lots;
detecting a defect pattern of the sub lots, wherein the defect pattern corresponds to a rotational combination, and the rotational combination is associated with the designated combination of rotational angles of the plurality of sub lots and the number of the plurality of sub lots; and
identifying the group of manufacturing machines corresponding to the rotational combination.

10. The method of claim 9, wherein the rotational combination is identified by comparing the orientation of the defect patterns with the orientation of a reference defect pattern to obtain the corresponding rotational combination of the defect pattern.

11. The method of claim 10, wherein the plurality of sub lots of wafers comprises a reference sub lot of wafer, and the reference sub lot of wafer remains at the reference orientation during each of the subsequent group of manufacturing machines and acts as a reference defect pattern when a defect pattern is detected.

12. The method of claim 9, wherein each group of manufacturing machines comprises at least one manufacturing machine.

13. The method of claim 9, wherein each of the sub lot of wafers comprises at least one wafer.

14. The method of claim 9, wherein a granularity of the groups of manufacturing stages is improved by decreasing the magnitude of the rotational angels of the designated combination of rotational angles.

15. The method of claim 9, wherein a granularity of the groups of manufacturing stages is improved by increasing the number of the sub-lots.

16. The method of claim 9, wherein a granularity of the groups of manufacturing machines is improved by offsetting the grouping of manufacturing machines of each lots of the wafers.
